(19) United States
(12) Patent Application Publication
(10) Pub. No.: US 2009/0273543 A1
(43) Pub. Date: Nov. 5, 2009

(54) System and method for updating updateable wall art

(76) Inventor: Paul McVinney, Accoreek, MO (US)

Correspondence Address: David E. Orr, 4616 NE 134th Street, Vancouver, WA, 98686, US

(21) Appl. No.: 12/150,990

(22) Filed: May 1, 2008

(51) Int. Cl. G09G 3/28

(52) U.S. Cl. 345/60

(57) ABSTRACT

A system and method for updating or changing a digital display device for presenting and showing wall art, the device comprising a flat LCD display configured with a processing element for receiving, storing, selecting and presenting images from external sources. The digital display device communicates with an external service or server that stores images, and sound files, sent to the display device. The processing element has storage for storing images and communications means, such as WIFI, for receiving images from external sources. Images and sound files are received and stored in the processing element, wherein images are displayed and sounds played based upon selection by an external selection device, or images may be selected for display based upon a time of day, date or may be selected based upon some pre-determined criteria, such as season or time of the year. An external server may update the display based upon a subscription service or business arrangement between the owner of the updateable wall art and a seller of digital content.

### FIELD

The present invention is related to visual display devices; more specifically the invention relates to a large display device hung on a wall to display digital works of art or commercial photography and a business method for updating those works of art and photos.

### BACKGROUND

With the advent of inexpensive high-definition flat screen LCDs (liquid crystal displays), new applications for visual display are now possible. These displays, now found in stores everywhere, are capable of displaying in very high resolution using millions of colors.

One such application is the utilization of LCD technology in updateable wall art, and methods for updating such displays.

### OBJECTS

Therefore in view of the desirability and need for a system and method for changing or updating an adaptable digital display displaying wall art, an invention is disclosed having a number of objects and benefits.

A first object is a digital display for use on a wall or in a room, the display accepting updates of images from an external source, wherein the source is a business that updates digital wall display devices. (Do we need this sentence? It sounds like the one below it. YES.)

A second object is a a wall mounted digital display that accepts images for display and sound files for playing, the images and sound sent via communications transmission from an external server based upon a business arrangement.

A third object is a device that displays images and sound from updateable files that are updated based upon a time or some other criteria by accessing an external server according to the criteria.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

According to the stated objects and benefits, a system and method for updating a digital display device presenting and showing wall art, the device comprising a flat LCD display configured with a processing element for receiving, storing, selecting and presenting images and playing sound files sent from external sources.

Images and sound are received and stored in the processing element, wherein images are displayed based upon selection by an external selection device or server, or images may be selected for update and eventual display based upon a time of day, date or may be selected based upon some pre-determined business arrangement, such as a subscription by the updateable wall art owner to a business service.

The business arrangement may include the updateable wall display owner obtaining downloads of images based upon a time interval of update or based upon the occurrence of a season, or may be based upon a subscription, such as the owner subscribing to digital prints of museum art.

As an example, a museum may, using the system and method of the invention, provide updateable display devices, and based upon donations or subscriptions to the museum, the museum, will send images or sound recordings to the subscriber.

### BRIEF DESCRIPTION OF DRAWINGS

FIG. 1 illustrates or shows a conceptual view of the device mounted upon a wall and displaying a digital image.

FIG. 2 shows a view of the digital display device wherein an external device selects an image (stored in the device) for display.

FIG. 3 shows the display enclosed or included in a frame, whereby the device is mounted on a wall.

FIG. 4 shows the device having a digital storage device (such as a USB drive, or a DVD) for storing images for display.

FIG. 5 shows the device having a communications interface for receiving images for display.

FIG. 6 shows a block diagram of the display device.

FIG. 7A illustrates the components of the processing element used for receiving, storing, selecting and displaying images.

FIG. 7B illustrates use of an external selection device for selecting an image for display.

FIG. 8 illustrates a logical diagram for practicing the system and method of the invention.

FIG. 9 illustrates a museum—having art objects, sending images and/or sound files to museum members or benefactors. FIG. 9 illustrates the use of the invention as a service to museum benefactors.

### DETAILED DESCRIPTION

### An Exemplary Embodiment

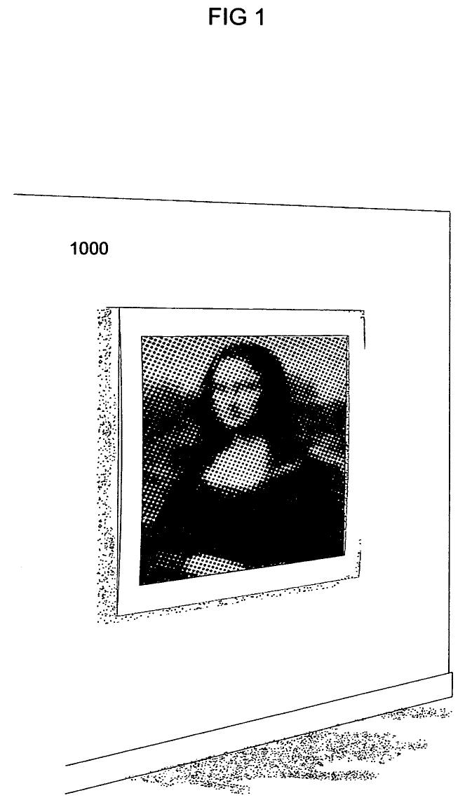

With reference to FIGS. 1, 2, 3, 4, 5, 6, 7A, 7B, and 8, an exemplary embodiment of the invention is disclosed. In the accompanying figures and description that follows, the invention is disclosed in the context of a service or business method that employs LCD displays, computer networks and telecommunications systems and software to provide a service wherein images and, optionally, sound recordings, may be transmitted to LCD displays.

FIG. 1 illustrates a digital display device 1000 for displaying one or more internally stored digital images. The display device 1000 may be mounted on a wall or may, using a holder, be set upon furniture or anywhere in a home or office.

With reference to FIG. 1, the display device comprises an LCD (liquid crystal display), each pixel of the LCD typically consisting of a layer of molecules aligned between two transparent electrodes, and two polarizing filters, the axes of polarity of which are perpendicular to each other. With no liquid crystal between the polarizing filters, light passing through one filter would be blocked by the electrodes.

The surfaces of the electrodes that are in contact with the liquid crystal material are treated so as to align the liquid crystal molecules in a particular direction. This treatment typically consists of a thin polymer layer that is unidirectionally rubbed using a cloth (the direction of the liquid crystal alignment is defined by the direction of rubbing). Before applying an electric field, the orientation of the liquid crystal molecules is determined by the alignment at the surfaces. In a twisted nematic device (still the most common liquid crystal device), the surface alignment directions at the two electrodes are perpendicular, and so the molecules arrange themselves in a helical structure, or twist.

Because the liquid crystal material is birefringent, light passing through one polarizing filter is rotated by the liquid crystal helix as it passes through the liquid crystal layer, allowing it to pass through the second polarized filter. Half of the incident light is absorbed by the first polarizing filter, but otherwise the entire assembly is transparent.

When a voltage is applied across the electrodes, a torque acts to align the liquid crystal molecules parallel to the electric field, distorting the helical structure (this is resisted by elastic forces since the molecules are constrained at the surfaces). This reduces the rotation of the polarization of the incident light, and the device appears gray. If the applied voltage is large enough, the liquid crystal molecules are completely untwisted and the polarization of the incident light is not rotated at all as it passes through the liquid crystal layer. This light will then be polarized perpendicular to the second filter, and thus be completely blocked and the pixel will appear black. By controlling the voltage applied across the liquid crystal layer in each pixel, light can be allowed to pass through in varying amounts, correspondingly illuminating the pixel.

The optical effect of a twisted nematic device in the voltage-on state is far less dependent on variations in the device thickness than that in the voltage-off state. Because of this, these devices are usually operated between crossed polarizers such that they appear bright with no voltage (the eye is much more sensitive to variations in the dark state than the bright state). These devices can also be operated between parallel polarizers, in which case the bright and dark states are reversed. The voltage-off dark state in this configuration appears blotchy, however, because of small thickness variations across the device.

Both the liquid crystal material and the alignment layer material contain ionic compounds. If an electric field of one particular polarity is applied for a long period of time, this ionic material is attracted to the surfaces and degrades the device performance. This is avoided by applying either an alternating current, or by reversing the polarity of the electric field as the device is addressed (the response of the liquid crystal layer is identical, regardless of the polarity of the applied field).

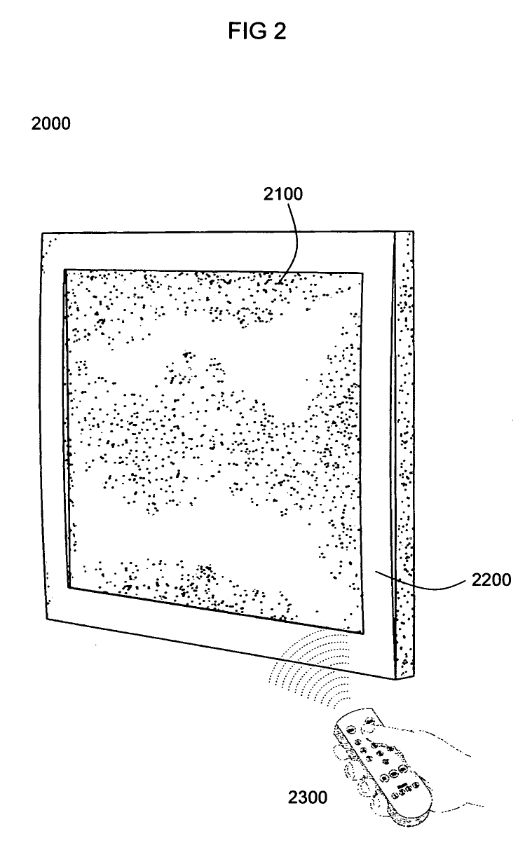

FIG. 2 shows the device 2000 comprising a display device 2100 mounted within a frame 2200. Images may be selected for display by an external selector 2300 similar to a television remote control.

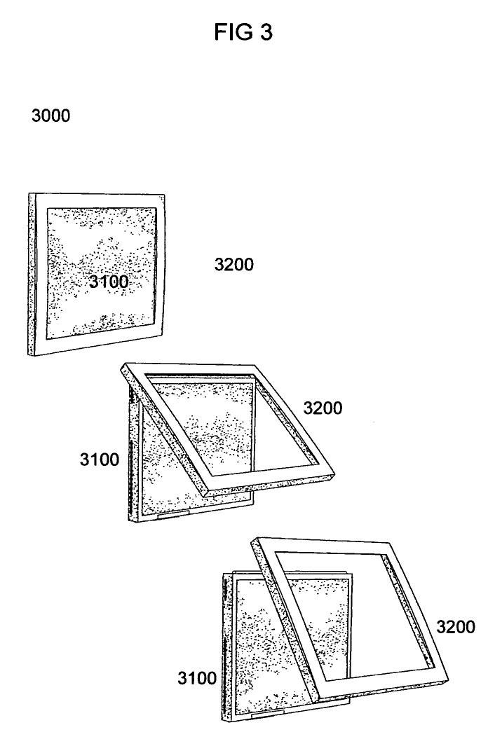

FIG. 3 shows the removal of the frame 3200 from the display device 3100.

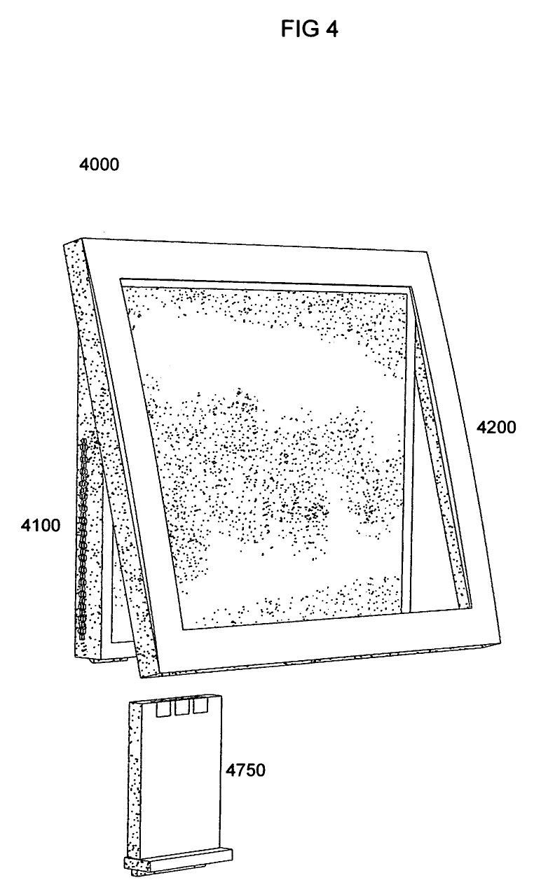

FIG. 4 shows the device 4000 having a display 4100 with internal components for storing and displaying digital images. In FIG. 4, a storage device 4750 is shown as part of the device 4000. The storage device 4750 may be a USB (“jump”) drive, or a CD or DVD drive.

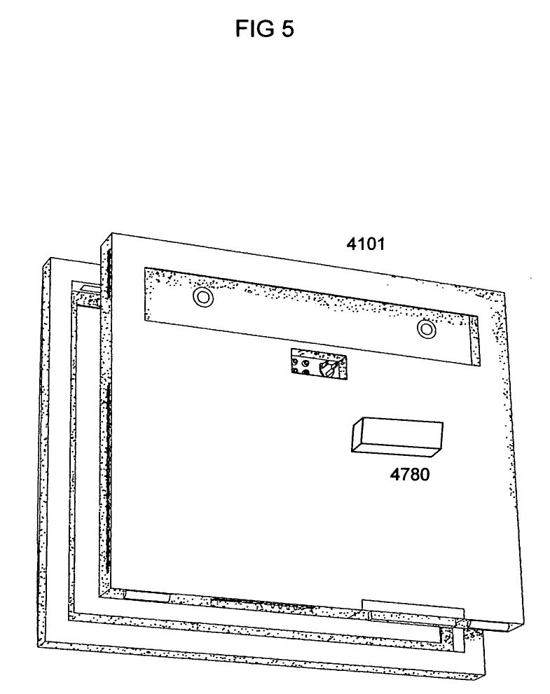

FIG. 5 illustrates the device 4100 having a recess 4101 for attachment and a recess 4102 for receiving 4102 for accepting a communications module 4780. The communications module 4780 may operate as a WIFI device, or any spread spectrum communications device, or may utilize DSL or cable modems for sending and receiving.

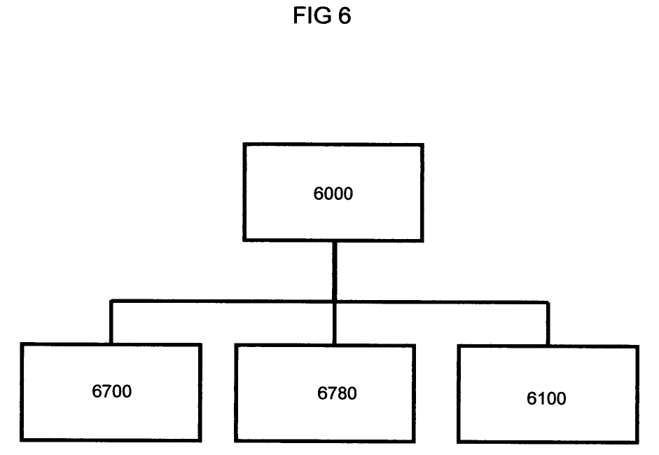

FIG. 6 shows the device as a block diagram, the device comprising a display element 6100 a communications element 6780 and as a processing element 6700, which controls the display 6100 and the communications element 6780. The processing element 6700 is programmed to receive and store images and sound files by the communications element 6780 by means of the WIFI device shown in FIG. 4 as 4780. The processing element 6780 also stores images and sound files in its storage or memory, and by some external means responds to commands to select an image for display and a sound file to play or to receive an image or sound file for storage in its memory.

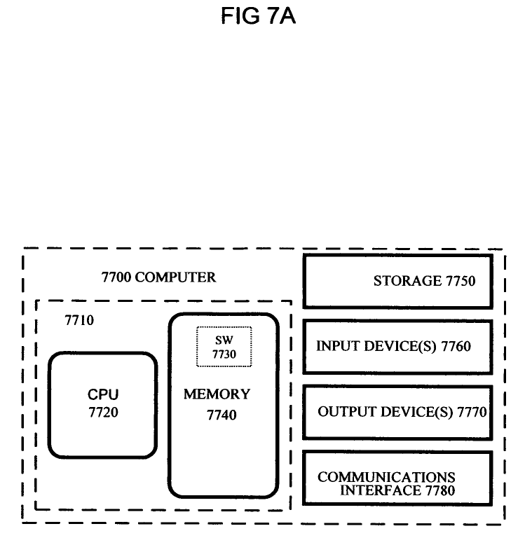

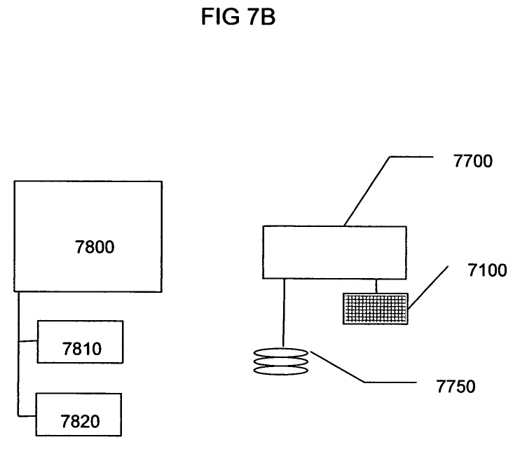

FIG. 7A shows an exemplary embodiment of the processing element implemented as a computer 7700.

With reference to FIG. 7A, control, access and update of the display device may be implemented; for example, within a computing environment 7700, which includes at least one CPU 7720 and memory 7740. In FIG. 7A, this most basic configuration 7700 is included within a dashed line. The CPU 7720 executes computer-executable instructions and may be a real or a virtual processor. In a multi-processing system, multiple processing units execute computer-executable instructions to increase processing power. The memory 7740 may be volatile memory (e.g., registers, cache, RAM), non-volatile memory (e.g., ROM, EEPROM, flash memory, etc.), or some combination of the two. The memory 7740 stores executable software—instructions and data 7730—written and operative to execute and implement the software applications required for an interactive environment supporting practice of the invention.

The computing environment shown in FIG. 7A may be implemented within the display device and is also representative of an external server that may update the display device according to a subscription service or business arrangement.

The computing environment may have additional features. For example, the computing environment 7000 includes storage 7750, one or more input devices 7760, one or more output devices 7770, and one or more communication connections or interfaces 7780. An interconnection mechanism (not shown) such as a bus, controller, or network interconnects the components of the computing environment, for example, computers having images which may be transferred to the invention. Typically, operating system software (not shown) provides an operating environment for other software executing in the computing environment, and coordinates activities of the components of the computing environment.

The storage 7750 may be removable or non-removable, and includes magnetic disks, CD-ROMs, DVDs, or any other medium which can be used to store information and which can be accessed within the computing environment. For example, the storage may store images that are to be displayed on the updateable wall art. The storage 7750 also stores instructions for the software 7730, and is configured, for example, to store signal processing algorithms, databases storing image files, database software systems, intermediate results and data generated from inputs.

The input device(s) 7760 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 7770 may be a display, printer, speaker, or another device that provides output from the computing environment.

The communication interface 7780 enables the operating system and software applications to exchange messages over a communication medium with the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 7780 is used to communicate with external devices such as a communications enabled controller for selecting images. For example, the interface 7780 may be attached to a network, such as the Internet, whereby the computing environment 2000 interchanges command, control and feedback signals with other computers, which may store images for display.

Software 7730 in the processing element 7700 is programmed to present images according to several criteria; among these are (1) time-of-day; (2) day of week or month; (3) holidays or special occasions.

FIG. 7B illustrates an external device, for example a hand-held control device 7800 for selecting images for display. In FIG. 7B, the control device is equipped with an input 7810, such as a touchpad or keypad 7810. The control device 7800 communicates with the processing element in the display 7700 by WIFI means 7820. From the keypad 7810 an image is selected and the selection is communicated to the processing element 7700, which retrieves the selected image from the processing element storage 7750, which is displayed upon the display 7100.

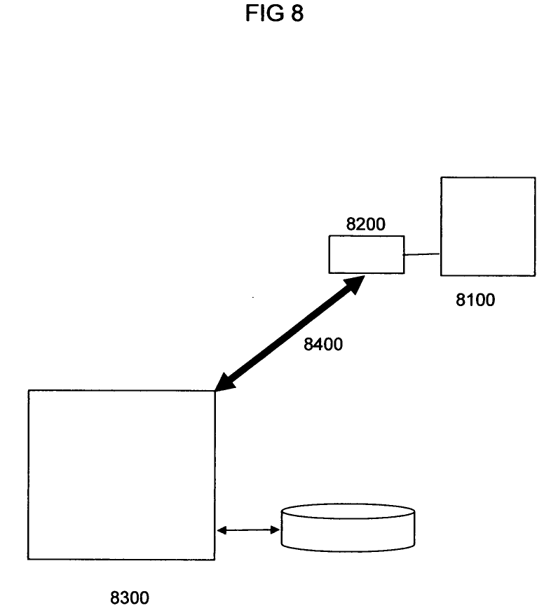

FIG. 8 illustrates an alternative method by which the updateable wall art display receives updates. In FIG. 8, the device of the updateable wall art 8100 is furnished with a communications means 8200 in accordance with the previous description recited. An external server 8300 is in communications with the device 8100, for example by Internet access and communications means 8400. Based upon a subscription or service contract or business relationship, the server 8300, at a time or place dictated by the service agreement, forms a connection with the processing element within the device 8100. Upon establishing connection, the server 8300 transmits images to the device 8100. After update the processing element in the device 8100 displays images received from the server 8300 update.

The server 8300 may update images in the device 8100 according to a service contract or business arrangement. Images may be updated based upon a season or time of year or some other prearranged occasion. Images sent by the server may be classical art, Christmas or other seasonal images. The images may be augmented by sound, such as may be found in an MPEG or AVI file.

The business arrangement for acquiring the images is the purchase of one image at a time or packs of images that are shown in a timed sequence on the display 7100. The selection of digitized art available for customers to purchase is as varied as the art found in a commercial gallery. Prospective buyers can browse categories of images, view thumbnail versions of available images, search for particular types of images, search by artist, or specially request a particular image. Owners of the device can purchase more than one image at a time, and more than one type of image at a time. Images are sold via an online payment service (like Paypal) or secure server accepting credit or debit cards.

The images are high resolution digitized versions of works of original art. In their original form, the images that are digitized can be any two dimensional media (oil, watercolor, ink, pencil, etc.) Original works of art include commercial still photography of all kinds, such as single and family portraits, landscape, nature, sports, etc. Original works of art can include famous two dimensional art that is in the public domain and does not require a license from the artist. This includes ancient drawings, hieroglyphics, scrolls, religious art, master works, maps/charts, early photography (daguerreotype, glass plate, etc.), and book prints/plates. The images can be moving images, either digital video or the digitized versions of analog videos or films. Moving images can be prerecorded or live images. Prerecorded images can be commercial or private films. Live digital video can be streaming images of attractive or famous places (Times Square, Eiffel Tower, Great Wall of China) with normal day to day activity occurring in the moving image.

Artists or photographers agree to license or sell their works through a business arrangement. The arrangement can be a short or long term license, or outright sale. Payments to artists or photographers can be a sale price for each image or video, a sale prices for sets/collections of images or videos, or be a variable fee based on the number of their images that are downloaded, the number of times an image is shown on a device 7100, or the time a video is streamed to a device 7100. Artists can be represented by a commercial art/photography broker or auction house, or they can represent themselves. Commercial photography businesses can use the business arrangement as an alternative means of reaching a national or international marketplace.

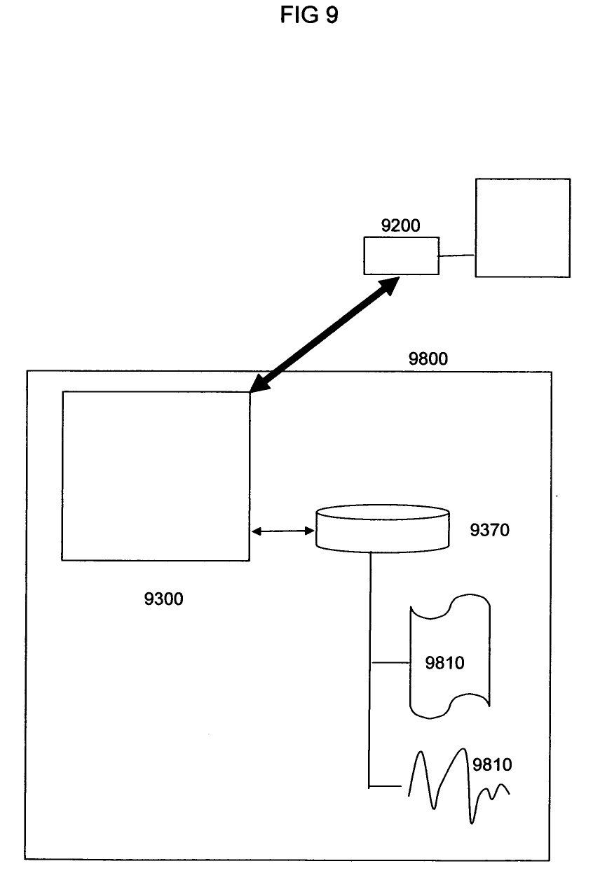

FIG. 9 depicts a museum utilizing the system and method of the invention to provide facsimile of its collections to subscribers, patrons and benefactors. Referring to FIG. 9, a museum 9800 has a collection of art objects 9810, which may comprise images (paintings, lithographs, posters, etc.) and sound files (recordings of native chants, etc.). A benefactor of the museum acquires or is provided by the museum, an updateable device 9200. As part of the subscription or patronage to the museum 9800, a server 9300 associated with the museum 9800 accesses to updateable device, and transmits images and or sound files 9810 from a database 9370 attached to the server 9300 to the updateable wall device 9200. The database 9370 has scanned or copied images or sound files 9810 of the museum's collection.

I claim:

1. A method for updating updateable wall art from a server, the method comprising:
providing a wall display device for displaying images and sound, the wall display device having storage for storing images and sound, the device having communications means for communicating with an external server, and;
providing a server storing images and sound;
whereby the server sends images and sound to the device according to a pre-arranged service agreement.
